(19) United States
(12) Patent Application Publication
(10) Pub. No.: US 2006/0152928 A1
(43) Pub. Date: Jul. 13, 2006

(54) Solid-state lighting device

(76) Inventor: James Bears, Boynton Beach, FL (US)

Correspondence Address: GIFFORD, KRASS, GROH, SPRINKLE & CITKOWSKI, P.C, PO BOX 7021, TROY, MI, 48007-7021, US

(21) Appl. No.: 11/329,688

(22) Filed: Jan. 10, 2006

Related U.S. Application Data
(60) Provisional application No. 60/643,090, filed on Jan. 11, 2005.

(51) Int. Cl. F21V 21/00; F21V 15/00

(52) U.S. Cl. 362/249; 362/362

(57) ABSTRACT

A solid-state lighting array for illuminating a predefined area includes a support member. A plurality of solid-state light-emitting devices is supported on the support member so that each device projects an essentially circular pattern of illumination onto the predefined area. At least a portion of the plurality of light-emitting devices is disposed so as to project a beam of light onto the predefined area at an oblique angle. The portion of obliquely angled devices have an astigmatic lens associated therewith so that the pattern of illumination incident upon the surface of the predefined area is essentially circular.

### FIELD OF THE INVENTION

This invention relates to illumination devices and more with more particularity to illumination devices having solid-state light emitting members.

### BACKGROUND OF THE INVENTION

Solid-state light-emitting devices, such as light-emitting diodes, electroluminescent devices, solid-state lasers, and the like, secure a number of advantages over prior devices, such as incandescent lamps and fluorescent lamps, as light sources for illuminating relatively large areas. Solid-state devices are generally very energy efficient, and have a very long service life. Furthermore, production techniques have greatly increased the reliability of these devices, while decreasing their cost. Consequently, solid-state light-emitting devices are being utilized for lighting applications wherein relatively large areas, such as parking lots, transit shelters, advertising displays, and the like, are illuminated. The energy efficiency of these devices makes them particularly advantageous for low power applications, such as photovoltaically powered applications, battery powered applications, and other “off-grid” applications.

Prior art solid-state illumination devices generally relied upon use of a cluster of light-emitting devices disposed in a conventional lighting fixture. Such prior art applications do not accommodate, or take advantage of, the particular requirements and characteristics of solid-state illumination devices. Such prior art applications do not produce a uniform beam of light to illuminate a large area. Additionally, light emitting diodes housed in conventional lighting fixtures may overheat and lead to a shortened service life.

There is therefore, a need in the art for an illumination system which is optimized for operation with light-emitting diodes and other such solid-state devices.

### BRIEF DESCRIPTION OF THE DRAWIGS

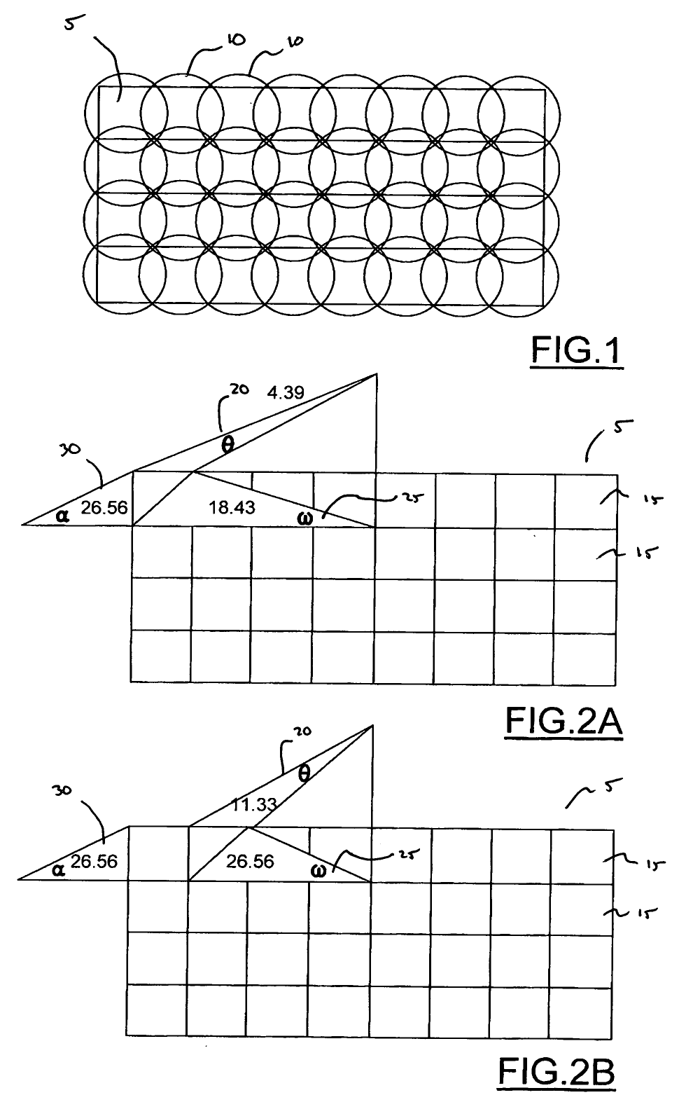

FIG. 1 is a top view of an area to be illuminated with a series of round light patterns superimposed thereon;

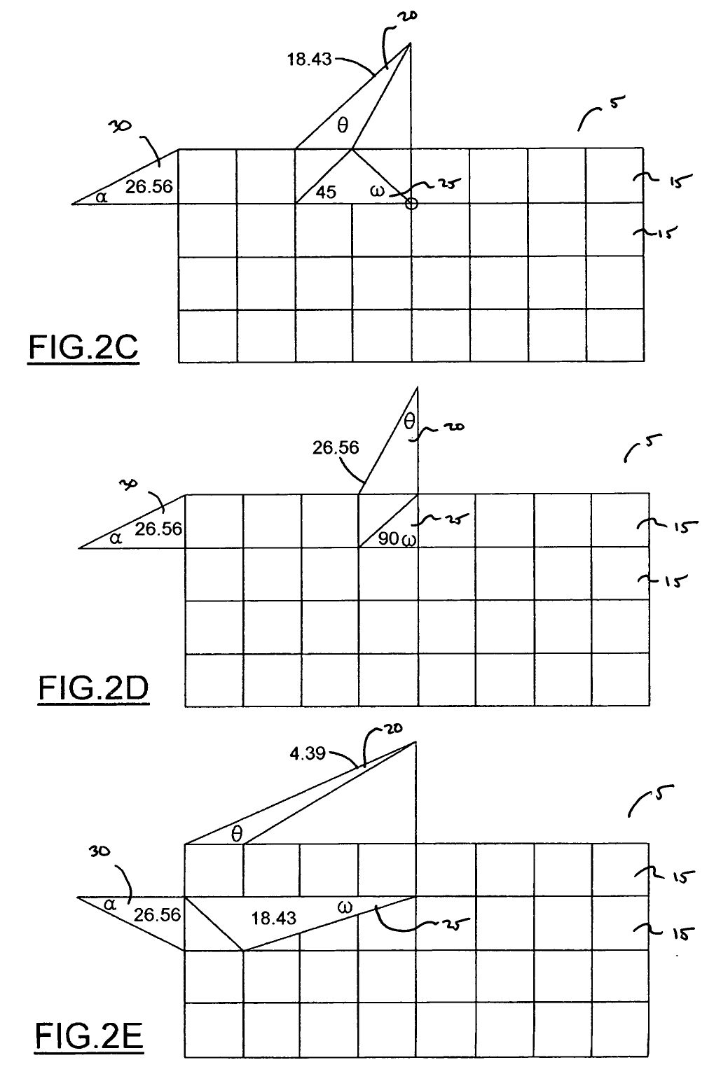

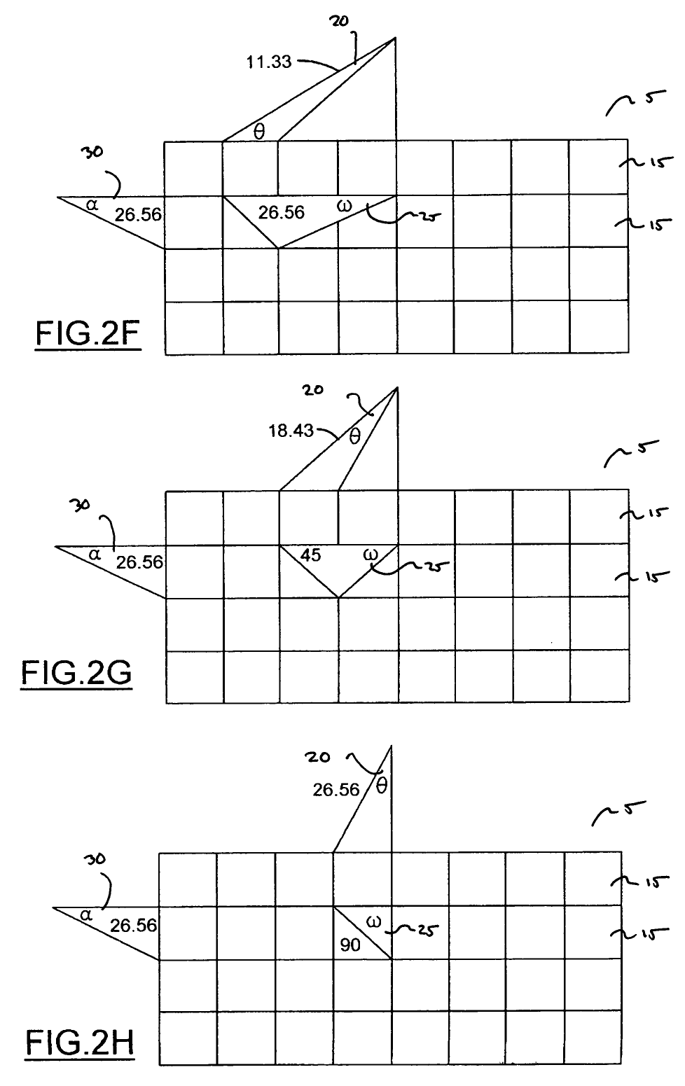

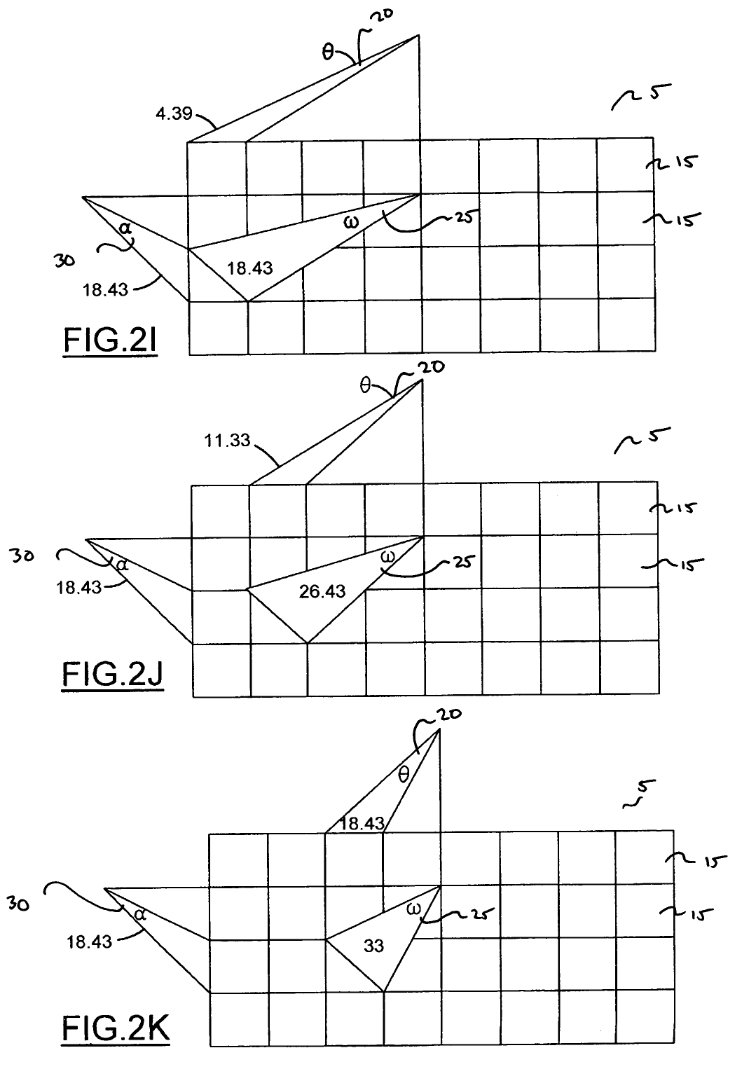

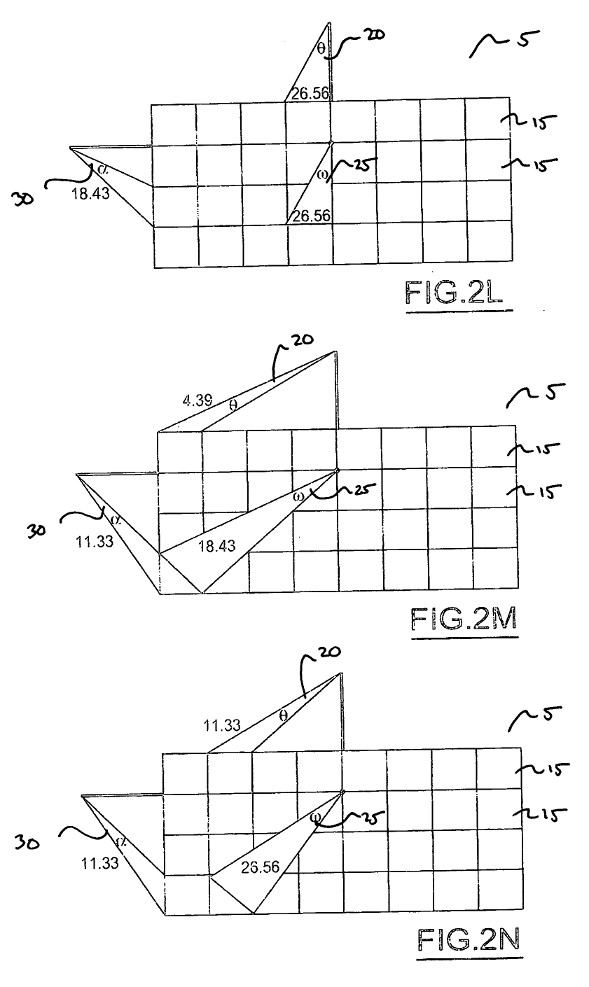

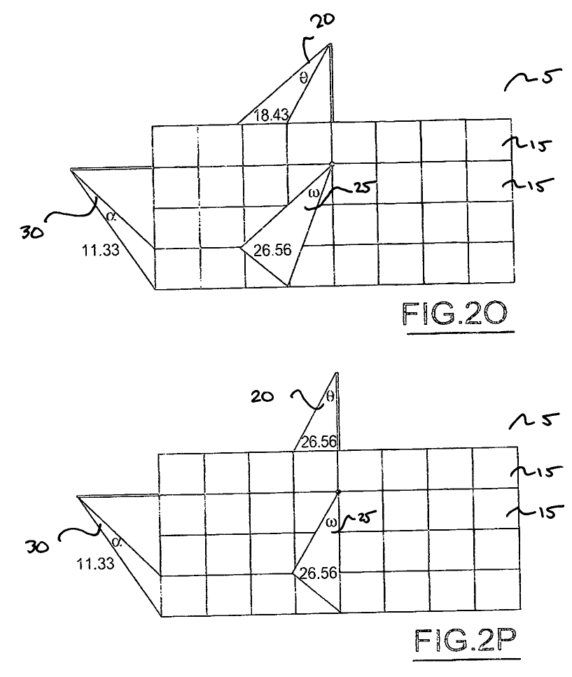

FIGS. 2A-P is a top view of the area of FIG. 1 divided into grids with angles shown thereon detailing the angular relationship of a light source relative to the grids;

FIG. 3 is a perspective view of a light emitting diode housing having an oblique interior surface allowing for angular manipulation of the position of the light emitting diode;

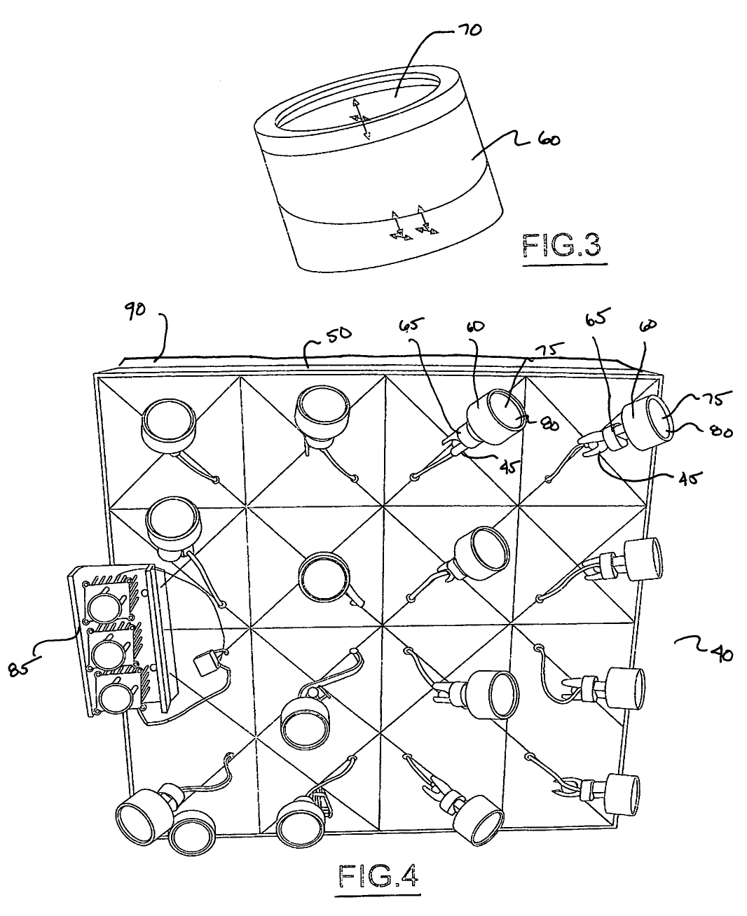

FIG. 4 is a bottom view of an illumination system having light emitting diodes attached thereto and positioned in various angular positions.

### SUMMARY OF THE INVENTION

A solid-state lighting array for illuminating a predefined area includes a support member. A plurality of solid-state light-emitting devices is supported on the support member so that each device projects an essentially circular pattern of illumination onto the predefined area. At least a portion of the plurality of light-emitting devices is disposed so as to project a beam of light onto the predefined area at an oblique angle. The portion of obliquely angled devices have an astigmatic lens associated therewith so that the pattern of illumination incident upon the surface of the predefined area is essentially circular.

### DETAILED DESCRIPTION OF THE INVENTION

Referring to FIG. 1, there is shown a depiction of an area 5 to be lit by an illumination device with circular patterns 10 disposed thereon, representing circular light beams from the illumination device. The circular patterns 10 of light overlap each other to form a basically uniform pattern of illumination on the area to be lit. Such an arrangement of light beams provides a relatively uniform distribution of light over a relatively large area.

FIGS. 2A-2P illustrates the area 5 to be lit of FIG. 1 divided into grids 15. The illustrated grid of FIG. 2 is a 4×8 array of equal area grids. Each of the figures includes three angles from a solid-state light source. A first angle, theta 20, represents the vertical angle of the light source relative to the grid section 15. A second angle, omega 25, represents a horizontal angle of the light source relative to the grid section 15. A third angle, alpha 30, represents a depth angle of the light source relative to the grid section 15. The three angles represent the proper astigmatism necessary to form a circular pattern of light for a given grid section. Referring to FIG. 2A, it can be seen that the angular values of the three angles from a light source to the outermost grid section are as follows: the first angle 20 has a value of 4.39 degrees, the second angle 25 has a value of 26.56 degrees, the third angle 30 has a value of 18.43 degrees. Each of the

FIGS. 2A-2P detail the angles for the astigmatism required from a light source to a given grid section. Table 1 summarizes the values of the angles for the FIGS. 2A-2P.

TABLE 1

| Figure | Theta | Alpha | Omega |
|---|---|---|---|
| 2A | 4.39 | 26.56 | 18.43 |
| 2B | 11.33 | 26.56 | 26.56 |
| 2C | 18.43 | 26.56 | 45 |
| 2D | 26.56 | 26.56 | 90 |
| 2E | 4.39 | 26.56 | 18.43 |
| 2F | 11.33 | 26.56 | 26.56 |
| 2G | 18.43 | 26.56 | 45 |
| 2H | 26.56 | 26.56 | 90 |
| 2I | 4.39 | 18.43 | 18.43 |
| 2J | 11.33 | 18.43 | 26.43 |
| 2K | 18.43 | 18.43 | 33 |
| 2L | 26.56 | 18.43 | 26.56 |
| 2M | 4.39 | 11.33 | 18.43 |
| 2N | 11.33 | 11.33 | 26.56 |
| 2O | 18.43 | 11.33 | 26.56 |
| 2P | 26.56 | 11.33 | 26.56 |

As can be seen by the values indicated in the table representing one half of the grids of the 4×8 array, the entire grid can essentially be covered with light sources for each grid and ten different types of astigmatisms. This can be further refined to 5 different astigmatisms by merging similar astigmatisms and rounding the numbers such that the 4×8 array can be covered by the following: 8 lights having a theta of 4 degrees and an alpha of 15 degrees; 12 lights having a theta of 20 degrees and an alpha of 10 degrees; 8 lights having a theta of 15 degrees and an alpha of 40 degrees; 2 lights having a theta of 15 degrees and an alpha of 30 degrees; and 2 lights having a theta of 20 degrees and an alpha of 20 degrees. This arrangement for an array of 4×8 lighting grids can similarly be done with any number of grids having a light source with the proper astigmatism to produce a circular pattern of light.

Referring to FIG. 4, the illumination system 40 of the present invention includes an array of solid-state light-emitting devices 45 mounted in a spaced-apart relationship upon a support member 50. The spaced-apart mounting allows for the dissipation of heat generated in the operation of the devices 45 and provides an optimized optical system wherein the output of each device may be specifically directed so as to most efficiently illuminate the area 5 to be lit. In one aspect of the present invention, the array of solid-state lighting devices 45 will illuminate a predetermined area 5 with a level of illumination of at least 0.5 lumens per square foot.

The support member 50 will typically be suspended above the surface to be lit by an appropriate device, such as a support pole.

In the present invention, the light-emitting devices 45 each project a cone of light onto the surface to be illuminated. Typically, the area to be illuminated is significantly larger than the area of the array of devices; therefore, at least some of the devices 45 will be aimed so that their light cones project outward of the array.

As can be seen in FIG. 4, each solid state lighting device 45 may be positioned in a housing 60 that is mounted in a moveable relationship to the support member 50. The solid-state lighting devices 45 may be mounted using a ball type joint 65 as shown in the figure, or it may otherwise be attached to the support member 50. For example, a housing 60, such as that shown in FIG. 3, may be rotatively attached to the support member 50 of the present invention. The housing 60 of FIG. 3 includes an oblique profile 70, such that as the housing 60 is rotated the lighting device 45 will change its angle relative to the surface to be lit. In this manner, the lighting devices 45 can be adjusted as necessary by the rotation of the housing 60.

The housing 60 of the present invention, receives a lens 75 or diffuser 80 having the proper astigmatism to project a circular cone of light on to a desired area. In another aspect of the present invention, the lighting device 45 may face in an opposite direction from the area to be lit such that the light is bounced off a reflector before projecting through the lens 75 or diffuser 80. The lens 75 of the present invention may be formed of any suitable material such as glass or a polymeric material having the requisite focusing properties and shape to achieve the desired astigmatisms of the present invention.

The lighting devices 45 may be individually mounted in a housing 60 and attached to the support member 50 in a grid like pattern or they may be grouped in a sub-array 85, as shown in FIG. 4. Such a sub array 85 may be utilized to provide a specific pattern of light on a desired area. The sub array 85 can include a lens 75 with the proper astigmatism to provide the circular pattern of light described above. The lighting devices may also be arranged in a variety of patterns as long as the spacing is such that one device does not block the light from another device.

As outlined above, a solid state light that projects a beam of light directly onto the surface so that the beam intersects the surface at a normal (90°) angle will not require adjustment to produce a circular light cone. However, a solid-state light source angled relative to the area to be lit would project a beam of light onto the surface at an oblique angle. Since the beam of light from the angled light source intersects the surface at an oblique angle, it would, in the absence of the present invention, form a pattern of illumination, which is approximately elliptical and would not have the same level of illumination, as would the circular pattern. Such an elliptical pattern would produce a lighting that is not uniform across the area. However, in accord with the principles of the present invention, the light-emitting devices 45 of the array, which project their beams at an oblique angle, each include an astigmatic lens 75. As is understood in the art, an astigmatic lens 75 is one that has varying focal properties across its surface. The astigmatic lens 75 may be optimized so that the obliquely projected beam will define an approximately circular pattern of illumination. It is understood that the astigmatic lens 75 may comprise a holographic optical element, or any other optical element accomplishing the requisite function.

A light cone produced from the solid-state lighting device 45 will travel farther to illuminate areas farther from the light source and will thus have a spread larger than a light cone closer to the light source. To achieve illumination of the same circular area per cone, those beams reaching further out must be more narrowly focused. The lenses 75 of the present invention for farther-reaching beams can have a narrower beam spread in addition to the astigmatism described above to achieve a more uniform circular pattern of light. Additionally, the light emitting devices 45 may be positioned on the support member 50 such that the adjacent beams overlap, as described above. This positioning of the light emitting devices 45 serves to compensate for the light drop off away from the center of the light emitting devices 45. In this manner the overlapping light from adjacent light emitting devices 45 combines to have a similar intensity as the center of the light produced by the light emitting devices 45, creating a more uniform light distribution.

As stated above, an array of solid-state light-emitting devices 45 may be mounted onto a support member 50 in an array in which the various devices are appropriately angled to, and coupled with, astigmatic lenses 75, so as to project a uniform pattern of illumination over a relatively large area. The astigmatic lenses 75 may have separate optical elements associated with individual light emitting devices 45; or they may be integrated into one or more units, each of which incorporates a plurality of elements that function as astigmatic lenses 75. Arrays of this type may be utilized for lighting large areas, such as parking lots, transit shelters, advertising displays, interiors of vehicles, and any other space in which uniform lighting is required.

In one aspect of the present invention, the solid-state lighting devices 45 may be photovoltaically powered and, in that regard, will include a photovoltaic generator panel 90. The light-generating array may include a separate support member 50 or alternatively the solid-state lighting devices 45 may be directly attached to the photovoltaic panel 90. In those instances whereupon installation is at an approximately equatorial position, the panel 90 will be roughly parallel to the surface to be illuminated. In higher latitudes, the panel 90 will be angled, and in either instance, the support may be appropriately configured to provide for proper placement of the generator and proper orientation of the light-emitting devices 45.

In photovoltaic installations, a power storage device, such as a battery or an array of batteries may be utilized to store energy produced by the photovoltaic panel for later use by the solid-state lights. Such a battery system may include, appropriate controllers and power regulators to monitor and regulate charging of the battery and illumination of the lamps.

It is to be realized that the array of the present invention may be utilized with any number of power sources, including alternating and direct current power sources. Batteries or a main power source from a municipality or generator may power the lights.

The invention has been described in an illustrative manner. It is to be understood that the terminology which has been used is intended to be in the nature of words of description rather than limitation. Many modifications and variations of the invention are possible in light of the above teachings. Therefore, within the scope of the appended claims, the invention may be practiced other than as specifically described.

1. A solid-state lighting array for illuminating a predefined area, the array comprising:
a support member;
a plurality of solid-state light-emitting devices supported on the support member, each device projecting an essentially circular pattern of illumination onto the predefined area;
wherein at least a portion of the plurality of light-emitting devices are disposed so as to project a beam of light onto the predefined area at an oblique angle, the devices of the portion of the plurality of devices having an astigmatic device associated therewith so that the pattern of illumination incident upon the surface of the predefined area is essentially circular.

2. The solid-state lighting array of claim 1, wherein each of the solid-state light emitting devices includes a housing angularly mounted to the support member.

3. The solid-state lighting array of claim 2, wherein the housing includes a ball joint for angular movement of the solid-state lighting device relative to the support member.

4. The solid-state lighting array of claim 2, wherein the housing includes an oblique shape such that rotation of the housing relative to the support member changes the angular relationship of the solid-state lighting device relative to the support member.

5. The solid-state lighting array of claim 1, wherein the plurality of solid-state lighting devices includes a sub array of solid state lighting devices supported on the support member.

6. The solid-state lighting array of claim 1, including a photovoltaic power source associated with the array, the power source being operative to energize the light-emitting devices.

7. The solid-state lighting array of claim 6, wherein the photovoltaic power source is supported by the support member.

8. The solid-state lighting array of claim 6, wherein the photovoltaic power source comprises the support member.

9. The solid-state lighting array of claim 6 including a battery for storing photovoltaically generated power and providing power to the plurality of devices.

10. The solid-state lighting array of claim 6 including a controller in electrical communication with the battery and the photovoltaic power source, the controller being operative to selectively deliver electrical power from the photovoltaic power source to the battery, and from the battery to the plurality of devices.

11. The solid-state lighting array of claim 1, wherein the plurality of devices comprise light-emitting diodes.

12. The solid-state lighting array of claim 1, wherein the astigmatic device comprises a lens.

13. The solid-state lighting array of claim 12 wherein the lens comprises a holographical optical device.

14. The solid-state lighting array of claim 1 wherein the astigmatic device comprises a diffuser.

15. The solid-state lighting array of claim 1 including a reflector associated with the solid-state lighting devices for directing light through the astigmatic device.

16. The solid-state lighting array of claim 1, wherein the array is operative to illuminate the predetermined area with a level of illumination of at least 0.5 lumens per square foot.

17. The solid-state lighting array of claim 1, wherein the astigmatic device transmits light in cones whose intersection, with the predetermined area to be illuminated, forms essentially circular areas of illumination of essentially the same size.

18. The solid-state lighting array of claim 1 wherein adjacent light emitting devices supported on the support member project beams of light in an overlapping pattern for creating a more uniform light distribution.

19. A solid-state lighting array for illuminating a predefined area, the array comprising:
a support member;
a plurality of solid-state light-emitting devices supported on the support member, each device projecting an essentially circular pattern of illumination onto the predefined area and each of the solid-state light emitting devices including a housing angularly mounted to the support member;
wherein at least a portion of the plurality of light-emitting devices are disposed so as to project a beam of light onto the predefined area at an oblique angle, the devices of the portion of the plurality of devices having an astigmatic device associated therewith so that the pattern of illumination incident upon the surface of the predefined area is essentially circular.

20. A solid-state lighting array for illuminating a predefined area, the array comprising:
a support member;
a plurality of solid-state light-emitting devices supported on the support member and spaced apart relative to each other;
wherein each of the plurality of light-emitting devices is angularly disposed relative to the support member so as to project a beam of light onto a portion of the predefined area, the plurality of devices having an adjustment device associated therewith for adjusting the beam of light so that the pattern of illumination incident upon the surface of the predefined area is essentially circular regardless of the angle of the plurality of lighting devices relative to the predetermined area.
